(19) United States
(12) Patent Application Publication
(10) Pub. No.: US 2026/0114961 A1
(43) Pub. Date: Apr. 30, 2026

(54) MAXILLARY MODELLER

(71) Applicants: Arash ZARRINPOUR, Paris (FR); Patrice BERGEYRON, CORSIER (CH)

(72) Inventors: Arash ZARRINPOUR, PARIS (FR); Patrice BERGEYRON, CORSIER (CH)

(21) Appl. No.: 19/101,366

(22) PCT Filed: Aug. 9, 2023
(86) PCT No.: PCT/EP2023/072013

§ 371 Date: Jan. 12, 2026

(30) Foreign Application Priority Data
Aug. 9, 2022 (FR) FR2208206

(51) Int. Cl. A61C 7/10; A61C 7/00; B33Y 50/00; B33Y 80/00

(52) U.S. Cl. CPC A61C 7/10; A61C 7/002; B33Y 50/00; B33Y 80/00

(57) ABSTRACT

The invention relates to a maxillary modeller (2) intended to be worn, in a service position, on a dental arch of a user in order to modify the shape of the palate, the maxillary modeller being one-piece and removable and comprising: —a central palatal portion (22) configured to be in contact with the user's palate when the maxillary modeller is in the service position; and —a first and a second dental portion (24; 26) each comprising at least one, preferably multiple cavities configured to receive teeth of the user when the maxillary modeller is in the service position, the first and second dental portions extending on either side of the central palatal portion, the central palatal portion being configured so as to exert on the palate, in the service position, forces suitable for modifying the shape thereof.

### TECHNICAL FIELD

The present invention relates to a maxillary modeller, a method for manufacturing maxillary modellers, and a device for manufacturing said maxillary modellers.

### PRIOR ART

In the context of malocclusion, it is sometimes necessary to perform maxillary expansion beforehand and/or to cause a change in the shape of the maxilla, making it possible to widen and/or modify an upper dental arch of a user.

To perform such maxillary expansion and/or to cause a change in the shape of the maxilla, a particular type of orthodontic appliance called a palate expander is conventionally used.

A palate expander is composed of two bearing parts connected by a central actuator, the actuator being operated at regular intervals to separate the bearing parts from each other laterally, thus progressively widening the palate. The bearing parts comprise wires configured to be fastened to the user's teeth in order to hold the palate expander on the user's palate. The bearing parts may also include resin zones intended to be pressed against the user's palate when the palate expander is placed in the mouth.

This type of orthodontic appliance therefore requires regular intervention by a third party, usually a relative or a dental professional, in order to operate the actuator to progressively separate the two bearing parts. Furthermore, these actions can lead to mishandling, or require numerous trips to a dental professional.

There is therefore a need to limit the number of trips to a dental professional and to facilitate the wearing of a palate expander.

Furthermore, a palate expander is conventionally manufactured manually by a professional, in particular a prosthetist, from an upper jaw molding in order to obtain a dental impression.

The professional initially curves metal wires intended to be hooked to the teeth of the individual and hold the palate expander, the curve of the metal wires being defined by positioning said wires on a dental impression of the upper jaw of the individual. The professional then manufactures a resin covering the zone corresponding to the palate on the dental impression of the upper jaw and positions an actuator in the resin. The resin is then cut into two parts at the actuator, so that when the actuator is operated, the two resin parts are separated from each other laterally.

The manual manufacture of these orthodontic appliances can cause discomfort or even pain, resulting for example from imprecise molding or from the positioning of the actuator in the resin, the palate expander potentially not being perfectly adapted to the user's palate.

There is therefore also a need to improve the manufacture of a palate expander.

In general, when the user's palate is particularly hollow and narrow, it is difficult to position the actuator against the user's palate. To overcome this problem, a large layer of resin is added, which can cause considerable discomfort.

Finally, food can become stuck in the palate expander, notably in the actuator or the wires.

There is a permanent need to improve user comfort, in particular with a view to improving compliance, but also user hygiene.

Apart from treating a malocclusion, it may also be useful to modify the shape of the palate, notably to modify the shape of the face. A change in the shape of the palate is not necessarily accompanied by an action on the upper (maxillary) dental arch, in particular to widen or narrow it. It may for example deform the palate locally, for example by locally enlarging a suture of the palate.

There is a permanent need for a simple and comfortable solution for the patient, to modify the shape of the palate, in particular without acting on the shape of the upper arch.

One object of the invention is to at least partially meet these needs.

### DESCRIPTION OF THE INVENTION

### Summary of the Invention

The invention provides a maxillary modeller intended to be worn, in a position of use, by a dental arch of a user to widen said dental arch and/or modify the shape of the palate, the maxillary modeller comprising:
a central palatal part configured to be in contact with the user's palate when the maxillary modeller is in the position of use,
first and second dental parts, each having at least one cavity, preferably a plurality of cavities configured to receive some of the user's teeth when the maxillary modeller is in the position of use,
   the first and second dental parts extending on either side of the central palatal part,
   the maxillary modeller being in one piece, removable and configured so that, in the position of use, the first and second dental parts each exert a force on the teeth to expand the dental arch and/or modify the shape of the palate.

The maxillary modeller according to the invention is in one piece, i.e. it forms a block having a constant geometry when at rest (i.e. in the absence of deformation stresses). In particular, it does not include an actuator. Any modification of the position of the actuator alters the resting geometry of the maxillary modeller.

Preferably, the maxillary modeller cannot be dismantled into several pieces.

In a preferred embodiment, the maxillary modeller does not include any metal wire.

A maxillary modeller according to the invention is advantageously used to limit the accumulation of food and thus improves dental hygiene.

The first and second dental parts can take the form of a fraction of a conventional orthodontic aligner. The first and second dental parts may have the conventional features of an orthodontic aligner, in particular the shape of the cavities of the first and/or second dental parts can be adapted, in the position of use, to hold the maxillary modeller in position on the teeth, while exerting stress on the teeth in order to widen the arch while modifying the arrangement of the teeth. A maxillary modeller according to the invention is advantageously used to modify the positioning of the teeth while widening the dental arch.

Alternatively, the shape of the cavities of the first and/or second dental parts is adapted, in the position of use, to hold the maxillary modeller in position on the teeth, while exerting stress on the teeth in order to widen the arch without modifying the arrangement of the teeth.

The central palatal part conforms to the shape of the palate while connecting the first and second dental parts.

The central palatal part may advantageously be configured so as to impose a particular shape on the palate, progressively modifying the shape of the palate.

Thus, when the maxillary modeller is in the position of use in the user's mouth, the modeller not only expands the dental arch but also simultaneously modifies the shape of the palate.

The maxillary modeller can be made of a polymer material, preferably transparent. In particular, it can be manufactured by 3D printing or by thermoforming.

The central palatal part may have a variable thickness.

Preferably, the thickness of the palatal part is substantially constant. The maximum and/or minimum and/or average thickness of the central palatal part may be greater than 0.5 mm, or greater than 1 mm and/or less than 7 mm, preferably less than 5 mm, preferably less than 3 mm.

The first and second dental parts may each have a variable thickness.

Preferably, the thicknesses of the first and second dental parts are substantially constant. In particular, the thicknesses of the first and second dental parts are substantially equal.

The maximum and/or minimum and/or average thicknesses of the first and second dental parts may be greater than 0.3 mm, or greater than 0.5 mm or greater than 1 mm and/or less than 3 mm, preferably less than 2 mm.

In a specific embodiment, the thickness of the central palatal part is greater at least at one point than the thicknesses of the first and second dental parts.

Preferably, the maxillary modeller is configured such that the first dental part exerts a force on the dental arch similar to but opposed to a force exerted on the dental arch by the second dental part.

As will be seen in greater detail in the remainder of the description, a maxillary modeller according to the invention is advantageously used to improve not only the dental hygiene but also the independence of the user. This is because the user can position the maxillary modeller in their mouth without needing any help. Such a maxillary modeller is easily to handle.

The invention also provides a method of manufacturing maxillary modellers according to the invention including the following successive steps:
a) generating a digital three-dimensional model of a dental arch intended to carry the maxillary modellers, called the “initial model”,
b) from the initial model, generating a treatment plan for widening the dental arch and/or modifying the shape of the palate by determining a final digital three-dimensional model, called the “final model”, and intermediate digital three-dimensional models, called “intermediate models”, the intermediate models representing configurations of the dental arch as expected at different times of the treatment plan, called “intermediate times”, with a view to achieving a final configuration of the dental arch, the final configuration being represented by the final model,
c) for each intermediate model and final model determined in step b), designing, by means of a computer, a maxillary modeller so as to obtain a series of maxillary modellers to be worn successively,
d) manufacturing the maxillary modellers, preferably by thermoforming or 3D printing.

Successive maxillary modellers are worn to modify the user's dental arch, and in particular to widen the dental arch progressively, and/or to modify the shape of the palate progressively. A first maxillary modeller is worn to widen the arch to achieve a configuration of the user's teeth that is similar, preferably identical, to the configuration of a first intermediate model. The final maxillary modeller, designed from the final model, is worn to widen the user's dental arch to achieve a configuration of the user's teeth similar, preferably identical, to the configuration of the final model. Similarly, the shape of the palate evolves progressively as a result of the forces exerted by the maxillary modeller on the palate while said maxillary modeller is being worn. In particular, the variable thickness of the central palatal part makes it possible to exert a greater or lesser force on the palate.

Maxillary modellers can be regularly changed to significantly improve the user's dental hygiene.

Instead of operating an actuator in the user's mouth to separate the two bearing parts from each other, the user need only remove one maxillary modeller and replace it with the next.

The user can, at regular intervals, change the maxillary modeller alone. This advantageously limits the number of trips to a dental professional and limits potential handling errors resulting from incorrect adjustment of the actuator of a palate expander.

Each of the maxillary modellers is preferably designed from an intermediate model or the final model, preferably in such a way that its shape reproduces all or part of the shape of said intermediate or final model, i.e. so as to have at least partially a complementary shape with said intermediate or final model.

Steps a) to c) of the method according to the invention can be implemented by computer, increasing precision during the design and manufacture of the maxillary modellers.

The method according to the invention may include one or more of the following optional features:
in step a), the initial model is generated by molding to obtain a dental impression of the arch, followed by digitization of the impression, or by acquisition of digital 2D or 3D images, for example using a 3D scanner or radiography;
step a) is implemented using a 3D scanner;
in step b), the treatment plan is determined by simulating tooth movements and splitting the simulation into steps, each step corresponding to the movements made to reach a configuration of an intermediate or final model, the simulation notably being carried out using computer software such as NEMOCAST 3D;
determining the treatment plan involves determining widening distances of the dental arch, preferably in tenths of a millimeter and/or hundredths of a millimeter, between two successive intermediate times, between an initial time, at which the initial model is acquired, and an intermediate time, and between an intermediate time and a final time;
in step b), determining the treatment plan involves determining a widening distance of the dental arch, preferably in tenths of a millimeter and/or hundredths of a millimeter, between two successive intermediate times, between an initial time, at which the initial model is acquired, and the first intermediate time immediately following the initial time, and between the intermediate time immediately preceding the final time and the final time,
in step b), determining the treatment plan involves a modification of the positioning of the teeth, in particular a rotation of at least one tooth with respect to adjacent teeth and/or a translational movement of at least one tooth with respect to the adjacent teeth;
in step b), determining the treatment plan involves a modification of the shape of the palate;
step b) is implemented by computer;
in step c), one or more maxillary modellers are designed to modify the positioning of one or more teeth intended to carry the first or second dental part;
the interval between two successive intermediate times is less than two weeks, better still less than ten days, preferably the interval between two successive intermediate times is substantially one week;
step c) is implemented by computer;
in step c), designing a maxillary modeller involves determining a material thickness for the central palatal part, a thickness for the first dental part and a thickness for the second dental part;
said thicknesses are different;
the central palatal part has a variable thickness and/or the first dental part has a variable thickness and/or the second dental part has a variable thickness;
step d) is implemented using a 3D printer;
after step d), the maxillary modellers are given or sent to the user.

The invention also relates to a computer program product comprising instructions which, when the program is executed by a computer, prompt said computer to implement steps b) and c), and preferably d), to control a manufacturing machine.

The computer program product in particular comprises instructions which, when the program is executed by a computer, prompt said computer to implement the following steps:
1) receiving a digital three-dimensional model of a dental arch intended to carry the maxillary modellers, called the “initial model”;
2) from the initial model, generating a treatment plan notably for widening the dental arch and/or modifying the shape of the palate by determining a final digital three-dimensional model, called the “final model”, and intermediate digital three-dimensional models, called “intermediate models”, the intermediate models representing configurations of the dental arch as expected at different times of the treatment plan, called “intermediate times”, with a view to achieving a final configuration of the dental arch, the final configuration being represented by the final model,
3) for each intermediate and final model determined in step 2), designing a maxillary modeller so as to obtain a series of maxillary modellers to be worn successively, each of the maxillary modellers being designed in a form-fitting manner with at least a part of an intermediate or final model,
4) sending manufacturing instructions for the maxillary modellers, preferably to a 3D printer.

The invention also relates to:
a computer program according to the invention, that is capable of controlling a machine for manufacturing maxillary modellers independently or in cooperation with an operator, for example a dental professional, the manufacturing machine being for example a 3D printer;
a data medium on which such a program is stored, for example a memory or a CD-ROM, and
a computer in which such a program is loaded.

The invention also relates to a device for manufacturing maxillary modellers including means for acquiring a three-dimensional model of a dental arch for implementing a step a) according to the invention, for example a 3D scanner, a computer program according to the invention for implementing steps b) and c), and preferably a manufacturing machine for implementing a step d) according to the invention, for example a 3D printer.

### Definitions

“User” means any person intended to wear a maxillary modeller according to the invention or any person for whom a method according to the invention is implemented, whether this person is ill or not.

The “position of use” is the position of a maxillary modeller once it has been fastened to a dental arch. Conventionally, the fastening can be deactivated by the user, by simply pulling the maxillary modeller.

A member fastened to the supporting arch is said to be “removable” if it can be detached by hand by the user. A maxillary modeller according to the invention is removable.

“Model” means a three-dimensional digital model. A model consists of a set of voxels.

The terms “comprise”, “include” or “have” should be interpreted broadly and without limitation, unless specified otherwise.

The qualifiers “right”, “left”, “top”, “bottom”, “above”, “below”, and “opposite” shall be interpreted with reference to the position of use.

### BRIEF DESCRIPTION OF THE DRAWINGS

Further features and advantages of the invention will become more clearly apparent on reading the following detailed description and on studying the appended drawing, in which:

FIG. 1 is an example of a palate expander;

FIG. 2 shows a maxillary modeller according to the invention, in a plan view and in a front view;

FIG. 3 is a schematic representation of a treatment plan;

FIG. 4 illustrates the design of a maxillary modeller according to the invention, seen from below and seen from the front;

FIG. 5 illustrates a manufacturing method according to the invention; and

FIG. 6 is a block diagram of a device according to the invention.

Further details and advantages of the invention are set forth in the following detailed description provided for illustrative and nonlimiting purposes.

### DETAILED DESCRIPTION

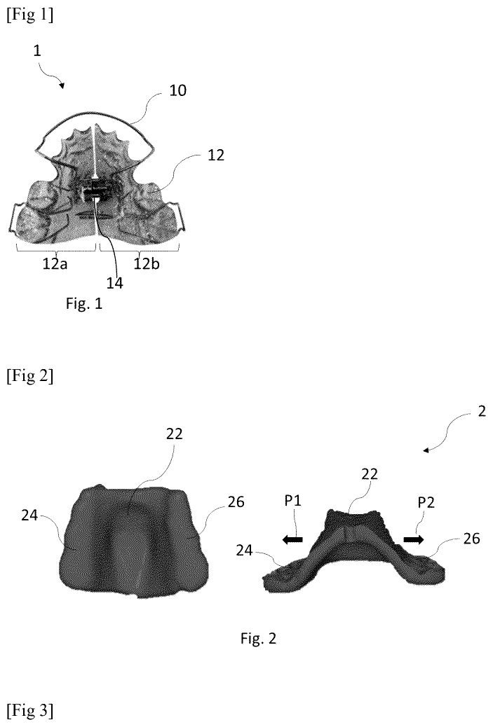

As is shown in FIG. 1, a palate expander 1 conventionally comprises metal wires 10 and an actuator 14, the metal wires and the actuator being held together by means of a resin plate 12, which is divided into two parts 12a and 12b at the level of the actuator in an anteroposterior direction. The actuator 14 is operated at regular intervals, laterally separating the two parts 12a and 12b from each other. This action requires manual intervention by an outside operator.

FIG. 2 shows a removable one-piece maxillary modeller 2 according to the invention, comprising a central palatal part 22, a first dental part 24 and a second dental part 26.

The maxillary modeller is shaped so that, in the position of use, it exerts transverse forces on the dental arch, toward the outside of the mouth, designated P1 and P2.

Preferably, the maxillary modeller 2 is made of a polymer material, preferably transparent.

The maxillary modeller 2 can be manufactured by 3D printing or by thermoforming.

These manufacturing methods allow automation of the manufacture of the maxillary modellers. The manufacture of a maxillary modeller can be carried out without human intervention.

The first and second dental parts 24, 26 can partly take the form of a conventional orthodontic aligner.

In particular, they can be shaped such that they allow the movement of the teeth, in rotation or in translation. Thus, in addition to allowing expansion of the palate, a maxillary modeller according to the invention also allows the teeth to be repositioned.

In a particular embodiment, a maxillary modeller 2 according to the invention is intended to be worn by a user for less than two weeks, better still less than ten days and/or more than 2 days. In a preferred embodiment, a maxillary modeller according to the invention is intended to be worn for one week.

The user can easily position, remove and change the maxillary modeller without the need for assistance by an outside operator.

Advantageously, a dental professional supplies a set of maxillary modellers according to the invention to the user, the maxillary modellers being configured to be worn successively, in a predefined order. The user can change the maxillary modellers at regular intervals, each maxillary modeller worn allowing palatal expansion of more than 1 tenth of a millimeter, more than 5 tenths of a millimeter and/or less than 100 tenths of a millimeter, less than 10 tenths of a millimeter.

Unlike the palate expanders 1 conventionally used, the maxillary modellers according to the invention adapt perfectly to the user's teeth.

The use of metal wires is then not necessary. The absence of metal wires and of an actuator facilitates maintenance of the orthodontic appliance and improves dental hygiene. Similarly, the regular changing of the maxillary modeller during treatment contributes to the improvement of dental hygiene during the treatment. Furthermore, the comfort of the user is improved.

The invention also relates to a method of manufacturing maxillary modellers according to the invention. A method according to the invention is illustrated in FIG. 5.

In step a), a digital three-dimensional model of the dental arch is generated, called the “initial model”.

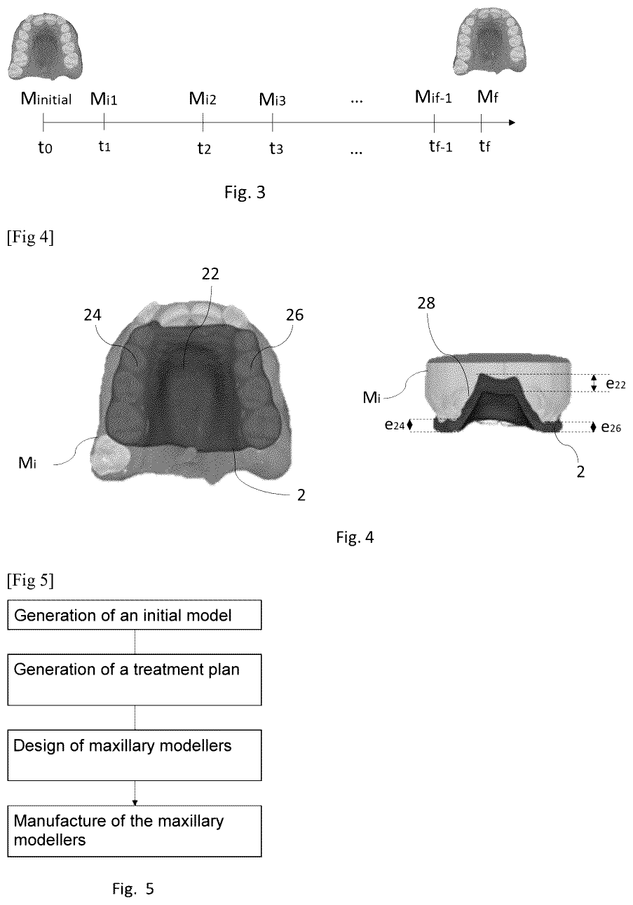

As is illustrated in FIG. 3, the initial model Mᵢₙᵢₜᵢₐₗ is generated at a time t₀, the configuration of the dental arch at the time t₀ representing the configuration of the dental arch before the implementation of palatal expansion treatment.

The initial model can be generated by any of the methods conventionally implemented with a view to obtaining a digital three-dimensional model of a dental arch of a user.

The initial model can be generated using a 3D scanner.

The initial model can be generated by molding the user's dental arch and then digitizing the dental impression obtained by molding. The impression is, for example, a plaster impression.

In step b), a treatment plan for palatal expansion is generated.

Step b) comprises the determination of a final digital three-dimensional model M_{f}, called the “final model”, and the determination of intermediate models Mᵢ₁, Mᵢ₂, Mᵢ₃, M_{if-1}, called “intermediate models”, the intermediate models representing configurations of the dental arch as expected at different times of the treatment plan t₁, t₂, t₃, t^{f-1}, called “intermediate times”, with a view to reaching a final configuration of the dental arch, the final configuration being represented by the final model M_{f}.

Preferably, the initial model is cut so as to isolate models for the first and second dental parts 24, 26. The two dental-part models are displaced, for example by an orthodontist, to reach the configuration of the final model, thereby simulating the course of the treatment plan and defining the intermediate models of the dental arch as expected at the intermediate times. The treatment plan is a simulation used to visualize the theoretical course of treatment.

An example outlining a treatment plan is shown in FIG. 3.

The treatment plan can be determined such that a duration between two successive intermediate times is less than two weeks, better still less than ten days and preferably more than 2 days. Preferably, the treatment plan is determined such that a duration between two successive intermediate times is substantially one week.

Intermediate models can be determined to simulate a palatal expansion of a few tenths or a few hundredths of a millimeter between two successive intermediate times, for example a palatal expansion of more than 1 tenth of a millimeter, more than 5 tenths of a millimeter and/or less than 100 tenths of a millimeter, less than 10 tenths of a millimeter.

The determination of a treatment plan can be carried out by means of a computer tool, for example by means of software such as NEMOCAST 3D.

The determination of a treatment plan is well known to a person skilled in the art.

Preferably, the determination of a treatment plan also includes the modification of the shape of the palate. Intermediate models are then determined to simulate a progressive modification of the palate. The intermediate and final models are thus adapted to ensure not only palatal expansion, but also a modification of the shape of the palate.

When tooth displacement is also desired during maxillary expansion, the initial model is preferably cut into tooth models. The tooth models of the intermediate and final models are then moved, for example by an orthodontist, to reach the configuration desired at the various intermediate times and at the final time. The intermediate and final models are thus adapted to ensure not only palatal expansion, but also a modification of the arrangement of the teeth.

In a particular embodiment, the intermediate and final models are adapted to ensure not only palatal expansion, but also a modification of the arrangement of the teeth and a modification of the shape of the palate.

In step c), a series of maxillary modellers is designed, the maxillary modellers being intended to be worn successively.

For each intermediate and final model, a maxillary modeller is designed.

In a preferred embodiment of the invention, the number of maxillary modellers designed is equal to the number of intermediate and final models determined at step b).

From the treatment plan illustrated in FIG. 3, it is possible, for example, to design a series of maxillary modellers in such a way that the maxillary modeller designed from the intermediate model Mᵢ₁ is intended to be worn between the time t₀ and the time t₁, the maxillary modeller designed from the intermediate model Mᵢ₂ is intended to be worn between the time t₁ and t₂, the maxillary modeller designed from the intermediate model Mᵢ₃ is intended to be worn between the time t₂ and t₃, etc., and the maxillary modeller designed from the final model M_{f} is intended to be worn between the time t_{f-1} and t_{f}.

FIG. 4 illustrates an example of the design of a maxillary modeller 2 on the basis of an intermediate model Mᵢ. The design may include determining a thickness e₂₂ of the central palatal part 22, a thickness e₂₄ of the first dental part 24 and a thickness e₂₆ of the second dental part 26. “Thickness of a part” can be understood to mean a maximum thickness, an average thickness, a minimum thickness, the thickness being variable over the entirety of the part in question.

Preferably, the thickness e₂₂ of the central palatal part is substantially constant and/or the thickness e₂₄ of the first dental part is substantially constant and/or the thickness e₂₆ of the second dental part is substantially constant.

The thickness e₂₄ of the first dental part and the thickness e₂₆ of the second dental part may be substantially equal.

The thicknesses e₂₂, e₂₄, e₂₆ preferably depend on the forces P₁, P₂ to be exerted on the dental arch to achieve the desired palatal expansion.

In a preferred embodiment of the invention, the design of each maxillary modeller involves determining an intrados surface 28 of said modeller defined in a form-fitting manner with the intermediate or final model on the basis of which the maxillary modeller is designed, then determining a thickness at each point of the intrados surface 28 determined beforehand, the thickness depending on the forces P₁, P₂ to be exerted on the dental arch to achieve the desired palatal expansion.

In particular, the thickness depends on the material used to manufacture the maxillary modeller.

The transmission of force is all the greater the more flexible the modeller is, and therefore the greater the local thickness is. By knowing the properties of the constituent material of a modeller, it is possible to evaluate, for example with a predictive computer model, the local stresses applied to this modeller when it is forced to adopt its shape in the position of use. Such a predictive model can also be used to determine the effect of a modification of the shape of a modeller, and in particular the effect of a local modification of thickness, on the constraints exerted by the modeller in the position of use. Conversely, the predictive model can be used to determine the shape, and in particular the thickness, of the modeller as a function of a desired set of constraints.

In particular, the methods conventionally used to design conventional orthodontic aligners can be used to design the modeller.

Step c) is implemented by computer. Step c) can be performed without operator intervention, using only the treatment plan determined in step b). Preferably, an operator supervises the implementation of step c).

In step d), the maxillary modellers determined in step c) are manufactured.

In a preferred embodiment of the invention, the maxillary modellers are manufactured by thermoforming or by 3D printing using a 3D printer.

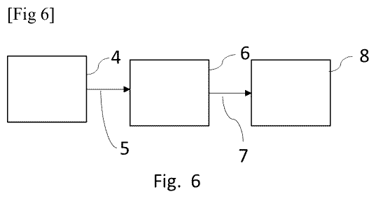

FIG. 6 is a block diagram of a device for implementing a manufacturing method according to the invention.

A device for implementing a manufacturing method according to the invention comprises means 4 for acquiring an initial model 2 for implementing a step a) of a method according to the invention, a computer program 6 comprising instructions which, when the program is executed by a computer, prompt said computer to implement steps b) and c), and a manufacturing machine 8 for implementing a step d).

The device may further comprise digital communication means 5 and 7. In particular, the device may comprise digital communication means 5 between the means 4 for acquiring the initial model and the computer program 6, enabling the transmission of the initial model from the acquisition means 4 to the computer program 6. The device may comprise digital communication means 7 between the computer program 6 and the manufacturing machine 8. For example, the computer program can send a file in STL format containing the instructions required to manufacture the maxillary modellers to the manufacturing machine, for example a 3D printer.

The manufacturing machine 8 may be a 3D printer.

The acquisition means 4 may be a 3D scanner.

As is now clearly apparent, a maxillary modeller according to the invention can be used to facilitate and automate the manufacture of orthodontic appliances for palatal expansion treatment.

Furthermore, a maxillary modeller according to the invention is not limited to performing a palatal expansion conventionally performed by a palate expander. Indeed, a maxillary modeller according to the invention can also be used to modify the shape of the palate and to modify the positioning of the teeth. In particular, modifying the shape of the palate has an impact on the shape of the face in general.

A maxillary modeller according to the invention also makes it possible to improve dental hygiene when wearing the maxillary modeller, considerably limiting the risk of food accumulating in the orthodontic appliance.

The comfort of the user when wearing a maxillary modeller is improved compared to wearing a palate expander, in particular due to the absence of metal wires and actuators, but also on account of the shape of the maxillary modeller, which adapts particularly well to the shape of the palate. The pausing and removal of the orthodontic appliance is also facilitated.

Finally, the maxillary modeller allows the displacement of teeth in parallel with palatal expansion, thereby accelerating the implementation of the orthodontic treatments.

### Example: Modification of the Shape of the Face

In a particularly advantageous embodiment, the invention is used to modify the shape of the palate, thereby modifying the shape of the face, for example for esthetic purposes, preferably exclusively for esthetic purposes.

Preferably, the shape of the cavities of the first and second dental parts is adapted, in the position of use, to hold the maxillary modeller in position on the teeth, without exerting stress on the teeth tending to widen the dental arch or to modify the arrangement of the teeth.

In a variant which is not preferred, the modification of the shape of the palate also has a therapeutic effect.

In one embodiment, the shape of the cavities of the first and/or second dental parts is adapted, in the position of use, to hold the maxillary modeller in position on the teeth, while exerting stress on the teeth in order to widen the arch and/or to modify the arrangement of the teeth.

The invention also relates to a method for manufacturing a series of maxillary modellers, said method including the following steps:
A) determining a desired face shape for the user, or “final shape”, preferably by means of esthetic or therapeutic rules, preferably exclusively esthetic;
B) manufacturing a series of maxillary modellers adapted to modify the shape of the user's face to bring it closer to the final shape, by deforming the user's palate.

In particular, the rules can set a value, or a range of values, for a parameter chosen from:
a distance between two points, for example a point in the middle of the forehead at the hairline, and a point between the superciliary arches, or between a point between the superciliary arches and a sub-nasal point, or between a sub-nasal point and a chin point;
a distance between the two corners of the patient's lips when smiling;
a width for a dentition depicted in a smile image;
a distance between a straight line passing through a point between the superciliary arches and a sub-nasal point, and the inter-incisal point between the upper central incisors;
a distance between a straight line passing through the junction of the upper first incisors and a straight line passing through the junction of the lower first incisors;
an angle between a straight line passing through at least two of the following points: a point between the superciliary arches, a sub-nasal point and an inter-incisor point, and a straight line passing through a point at the cusp of the left or right first premolar, and a point at the cementoenamel junction of the left or right first premolar respectively.

The number of rules is preferably greater than 2, 3, 5 and/or less than 50.

Simple tests can be used to establish a correlation between a shape of the palate and the values of the parameters. The operator can thus define a series of modellers allowing the shape of the palate, and thus the shape of the face, to be progressively modified until the desired shape is reached.

The series of modellers preferably includes more than 2, more than 5, more than 10 and/or less than 100 modellers.

Preferably, the series of maxillary modellers is manufactured by a process comprising the following successive steps:
a) generating a digital three-dimensional model Mᵢₙᵢₜᵢₐₗ of the palate and of the dental arch intended to carry the maxillary modellers, called the “initial model”,
b) from the initial model, generating a treatment plan for modifying the shape of the palate by determining a final digital three-dimensional model M_{f}, called the “final model”, and intermediate digital three-dimensional models Mᵢ, called “intermediate models”, the intermediate models representing configurations of the palate as expected at different times of the treatment plan, called “intermediate times”, with a view to achieving a final configuration of the palate, the final configuration being represented by the final model, the intermediate models being determined to simulate a progressive modification in the shape of the palate;
c) for each intermediate model and final model determined in step b), designing, by means of a computer, a maxillary modeller so as to obtain said series of maxillary modellers to be worn successively,
d) manufacturing the maxillary modellers, preferably from a polymer material, preferably transparent, preferably by thermoforming or 3D printing.

The final configuration of the palate is determined as a function of the predetermined desired shape for the user's face, preferably as a function of esthetic rules and/or therapeutic rules, in particular for limiting the risk of snoring.

The interval between two successive intermediate times is preferably less than 1 month, preferably less than two weeks, and more preferably less than ten days.

Notably in this example application of the invention, the central palatal part is configured, in the position of use, to exert forces on the palate that are adapted to modify the shape of the palate. Preferably, said forces are adapted to cause, in the position of use, a displacement of more than 1 tenth of a millimeter, more than 5 tenths of a millimeter and/or less than 100 tenths of a millimeter, less than 10 tenths of a millimeter, of at least one bone of the palate.

In one embodiment, said displacement modifies the volume of the user's oral cavity, for example by more than 5% or more than 10%, and/or less than 20%. In particular, the displacement may be at least partly radial with respect to the center of the user's oral cavity. The palatal part may, for example, push the bone upwards.

The palatal part may exert a different action on the palate, depending on the region of the palatal part considered. In particular, the intensity and/or orientation of the local force exerted by the palatal part on the palate, in the position of use, preferably depends on the region of the palatal part considered.

The palatal part is configured to act directly (without acting via the teeth) on the bones of the palate, in the position of use, preferably to modify the relative positions of said bones.

The modification of the relative positions of the bones leads to a modification of the shape of the user's face tending to bring said shape closer to the predetermined shape.

The invention also relates to a method of modifying the shape of a user's face, said method comprising the steps A) and B), and then the following step C):
C) the user wearing the maxillary modellers in a predefined order.

In one embodiment, step C) does not substantially modify the orientation of the teeth about their axes, and/or does not modify the general shape of the dental arch, in particular to widen or narrow it, and/or does not modify the occlusion.

In one embodiment, step C) has no therapeutic effect and/or is not followed (for example within one month or within 6 months of the end of step C)) by a therapeutic treatment, for example to correct a malocclusion. In particular, if the maxillary modellers modify the maxillary arch when they modify the shape of the palate, these modifications preferably have an exclusively esthetic effect. Step C) is not a step preceding an orthodontic treatment.

Of course, the invention is not limited to the embodiments described above and shown.

1. A maxillary modeller to be worn, in a position of use, by a dental arch of a user in order to modify the shape of the palate, the maxillary modeller being in one piece and removable and comprising:
a central palatal part configured to be in contact with the user's palate when the maxillary modeller is in the position of use,
first and second dental parts, each having at least one cavity configured to receive some of the user's teeth when the maxillary modeller is in the position of use,
the first and second dental parts extending on either side of the central palatal part,
the central palatal part being configured, in the position of use, to exert forces on the palate that are adapted to modify the shape of the palate.

2. The modeller as claimed in claim 1, wherein said forces are adapted, in the position of use, to cause a displacement of more than 0.1 millimeter of at least one bone of the palate.

3. The modeller as claimed in claim 2, wherein said displacement modifies the volume of the user's oral cavity.

4. The modeller as claimed in claim 1, wherein the palatal part is configured such that the intensity of the local force exerted on the palate by the palatal part in the position of use depends on the region of the palatal part in which said force is applied.

5. The modeller as claimed in claim 1, wherein the palatal part has a variable thickness.

6. The modeller as claimed in claim 1, wherein the palatal part is configured to modify the relative positions of the bones of the palate so as to modify the shape of the user's face in order to approximate said shape to a predetermined shape.

7. The modeller as claimed in claim 1, being made of a polymer material, preferably transparent.

8. The modeller as claimed in claim 1, produced by 3D printing and/or thermoforming.

9. The modeller as claimed in claim 1, wherein the shape of the cavities of the first and second dental parts is adapted, in the position of use, to hold the maxillary modeller in position on the teeth, without exerting stress on the teeth tending to widen the dental arch and/or without exerting stress tending to modify the arrangement of the teeth.

10. The modeller as claimed in claim 1, wherein the shape of the cavities of the first and/or second dental parts is adapted, in the position of use, to hold the maxillary modeller in position on the teeth, while exerting stress on the teeth in order to widen the arch and/or to modify the arrangement of the teeth.

11. A series of maxillary modellers as claimed in claim 1, the maxillary modellers being configured to progressively modify the shape of the user's face in order to make it conform to a predetermined shape when they are worn successively in a predefined order by the user.

12. A method for manufacturing a series of maxillary modellers as claimed in claim 11, said method comprising the following successive steps:
a) generating a digital three-dimensional model (Mᵢₙᵢₜᵢₐₗ) of the palate and of the dental arch intended to carry the maxillary modellers, called the initial model,
b) from the initial model, generating a treatment plan for modifying the shape of the palate by determining a final digital three-dimensional model (M_{f}), called the final model, and intermediate digital three-dimensional models (Mᵢ), called intermediate models, the intermediate models representing configurations of the palate as expected at different times of the treatment plan, called intermediate times, with a view to achieving a final configuration of the palate, the final configuration being represented by the final model, the intermediate models being determined to simulate a progressive modification in the shape of the palate;
c) for each intermediate model and final model determined in step b), designing, by means of a computer, a maxillary modeller so as to obtain said series of maxillary modellers to be worn successively, and
d) manufacturing the maxillary modellers, preferably by thermoforming or 3D printing.

13. The method as claimed in claim 12, wherein the final configuration of the palate is determined as a function of a predetermined shape for the user's face, said predetermined shape being determined as a function of esthetic rules and/or therapeutic rules, in particular for limiting the risk of snoring.

14. The method as claimed in claim 12, wherein the local thickness of the palatal part is determined as a function of the force that is to be exerted locally on the palate.

15. A method for manufacturing a series of maxillary modellers, wherein the maxillary modellers being configured to progressively modify the shape of the user's face in order to make it conform to a predetermined shape when they are worn successively in a predefined order by the user,
said method comprising the following steps:
A) determining a desired face shape for the user, or “final shape”, preferably by means of esthetic or therapeutic rules; and
B) manufacturing a series of maxillary modellers by a method as claimed in claim 12, such that the modification of the shape of the user's palate brings the shape of the user's face closer to the final shape.
